(19) United States
(12) Patent Application Publication
(10) Pub. No.: US 2014/0151508 A1
(43) Pub. Date: Jun. 5, 2014

(54) METHOD OF LANDING OF A SURVEILLANCE UNMANNED AERIAL VEHICLE AND A SURVEILLANCE UNMANNED AERIAL VEHICLE

(71) Applicant: WB Electronics S.A., (US)

(72) Inventors: WOJCIECH SZUMINSKI, Gliwice (PL); Ryszard Jurecki, Gliwice (PL); Grzegorz Krupa, Gliwice (PL); Adam Bartosiewicz, Warszawa (PL); Piotr Wojciechowski, Warszawa (PL)

(73) Assignee: WB Electronics S.A., Ozarow Mazowiecki (PL)

(21) Appl. No.: 13/689,853

(22) Filed: Nov. 30, 2012

(51) Int. Cl. B64D 1/08

(52) U.S. Cl. CPC B64D 1/08
USPC 244/137.1

(57) ABSTRACT

The mode of landing of an unmanned aerial vehicle driven by an electric engine, containing main power supply batteries, control systems of the surveillance head, transmitting and receiving systems, a flight control system, and a container equipped with a surveillance head with a looking down lens, placed in a recess situated in the lower part of the fuselage by which the vehicle is lightened at the last stage of flight shortly before landing, which means the container placed in the recess is detached, then moved outside the vehicle's body and descended by means of a parachute into a desired location, and the lightened vehicle lands in some other place. The recess in the fuselage contains an electrically controlled lock which fixes detachably the container equipped with at least one parachute placed at the bottom section of the container, on the side of the surveillance head.

### TECHNICAL FIELD

The subject of this invention is a method of landing of a surveillance unmanned aerial vehicle and a surveillance unmanned aerial vehicle. The invention is applied in an aerial observational vehicle propelled by an electric engine and containing in particular power supply batteries, surveillance head control systems, transmitting and receiving systems, a flight control system, and a container comprising a surveillance head with a down-looking lens placed in a recess at the bottom part of the fuselage, and by which the pilotless aircraft is lightened at the final stage of flight just before landing.

### BACKGROUND ART

Polish patent specification P.342068 describes a method of increasing the safety of the aircraft emergency landing consisting in that at the final stage of flight, before landing, when the chamber situated at the bottom part of fuselage has been opened, the baggage container with baggage is removed outside and/or the fuel tank is removed together with fuel by means of parachutes, and then a pneumatic bag placed at the bottom part of the baggage container is filled with pressurized air.

American patent specification U.S. Pat. No. 6,338,457 describes a parachute system of air objects recovery which enables safe landing of such objects in a chosen target location. The parachute system of regaining contains a cargo, a parachute or a paraglide, a system of servomechanisms, and an electronic control system. The parachute is of rectangular shape and is connected by shroud lines with the servomechanisms system built in the cargo and co-functioning with the electronic control system. The cargo may consist of landing air objects such as space vessels, air shooting targets and unmanned aerial vehicles for observation. The task of the system of servomechanisms and the electronic control system is to control the descend flight trajectory in such a manner that the cargo attached to the parachute lands safely. The servomechanisms system adjusts the length of each shroud line controlling the direction and fall velocity of the attached cargo.

The drawback of this known method is a complicated structure of the system which controls the servomechanism system which in turn adjusts the length of parachute shroud lines, and the impact of strong winds which may make it impossible to maintain correct parachute steering parameters.

Polish patent specification P.342068 describes a device increasing safety of the aircraft emergency landing, equipped with a balancing chamber cover to which internally there is detachably attached a fuel tank containing at least one parachute and/or baggage container equipped with at least one parachute, whilst the endings of movable segments of pneumatic servomotors are attached to the cover.

American patent specification US 2009/030887A1 describes a device which increases safety of landing of an unmanned aerial vehicle (UAV), said device having a movable protecting cover mounted on the top or at the bottom part of the fuselage and a chamber fitted with at least one parachute attached by shroud lines to the UAV fuselage near its gravity center. Shortly before landing, the movable segments of pneumatic servomotors reject the cover of the parachute chamber, and then pneumatic bags at the bottom part of the fuselage are filled with pressurized air.

The drawback of these known devices is the complicated structure of the system which controls the pneumatic servomotors system, and the necessity to use large pneumatic bags to protect the cargo and fuselage at the time of landing.

### SUMMARY OF THE INVENTION

In light of the foregoing, it is a first aspect of the present invention to provide a method of landing of a surveillance unmanned aerial vehicle and a surveillance unmanned aerial vehicle.

It is another aspect of the present invention to provide a method of landing of an unmanned aerial vehicle driven by an electric engine, containing the main power supply batteries, surveillance head control systems, transmitting and receiving systems, a flight control system, and a container equipped with a surveillance head with a looking down lens placed in a recess at the bottom part of the fuselage, wherein the unmanned air vehicle is lightened at the last stage of flight shortly before landing, characterized in that the container is detached from the recess situated at the bottom part of the fuselage, and then the container is moved outside the fuselage and descended by means of a parachute onto a requested place, and the lightened vehicle lands in another location.

Yet another aspect of the present invention is an unmanned aerial vehicle driven by an electric engine, containing a surveillance head control system, transmitting and receiving systems, a battery, and a container equipped with a surveillance head with a looking down lens placed in a recess at the bottom part of the fuselage, characterized in that in a recess of the fuselage an electronically controlled lock is mounted, whereby the lock fixes in a detachable manner a container furnished with at least one parachute placed in the lower part of the container, on the side of the surveillance head.

### BRIEF DESCRIPTION OF THE DRAWINGS

The subject of the invention is illustrated in its embodiments on the drawing, wherein:

FIG. 1 shows a safe surveillance aircraft with an attached container according to the concepts of the present invention, in a side view;

FIG. 2 depicts the plane shortly after detachment of the container, in a side view;

FIG. 3 represents the air vehicle after detachment of the container, in a side view; and

FIG. 4 shows the container rotated around its horizontal axis by 180 degrees, descending from a parachute, in a side view.

### BEST MODE FOR CARRYING OUT THE INVENTION

The method of enhancing the safety of landing of surveillance UAV is explained in

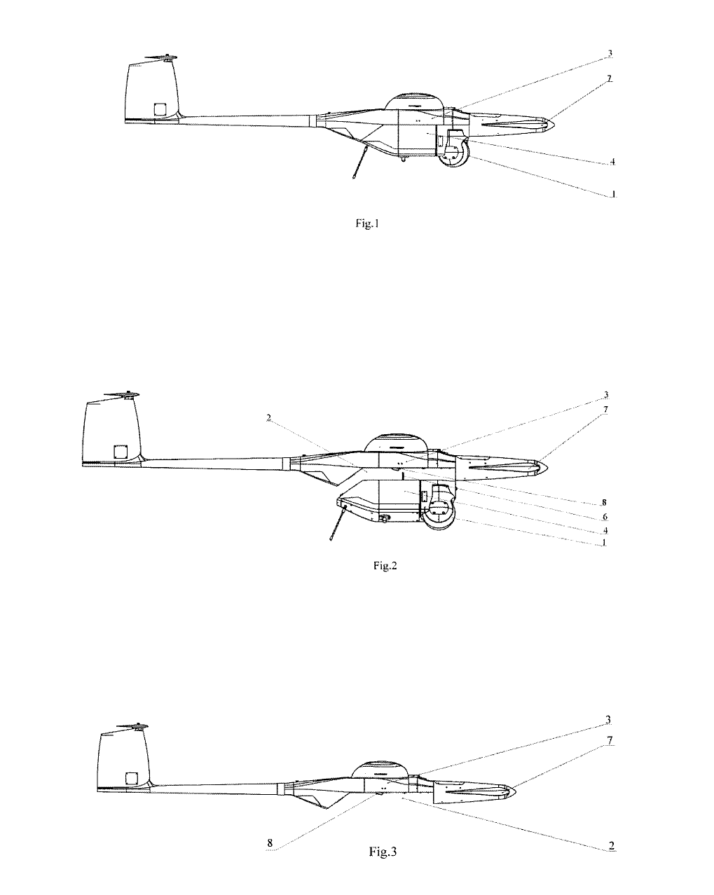

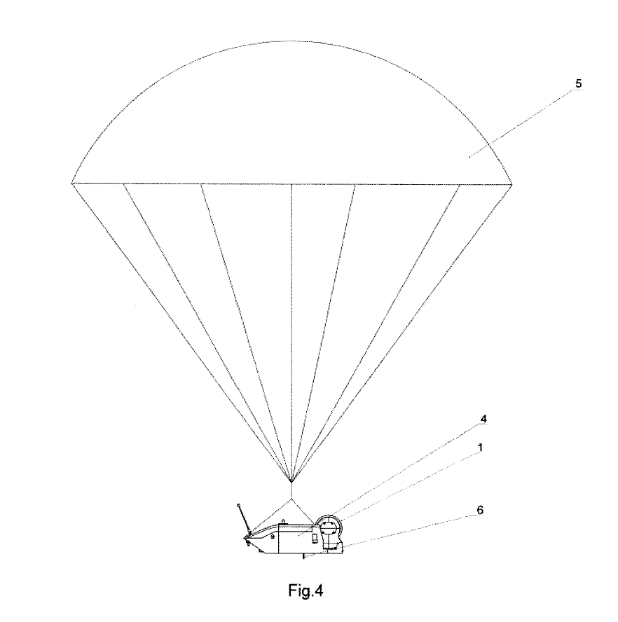

FIGS. 1-4 of the drawing. In a recess 2 of the fuselage 3 of an unmanned aerial vehicle a container 4 with main power supply batteries, a surveillance head, and a parachute 5 are fastened by means of the mandrel 6, and the unmanned vehicle is then sent on an observational mission, wherein the flight parameters and the flight route are monitored with the help of controlling and measuring apparatus. When the mission is over, the aircraft is guided to a landing place. In the vicinity of the landing place, a radio signal is emitted to the electronically controlled mandrel lock 8 situated within the recess 2 of the fuselage 3, said lock releasing the mandrel 6 situated in the upper part of the container 4. This moment is shown in FIG. 2. As visualized in FIG. 3, after detachment of the container 4 from the fuselage 3, the electric engine driving the propeller 7 is turned off, and then the propeller 7 collapses along the fuselage 3 axis, and with the use of flight control system powered by auxiliary batteries, the lightened aircraft is brought down to slide landing. FIG. 4 shows the container 4 detached from the fuselage 3 container, which influenced by the parachute 5 fixed near the surveillance head, slowly descends to the ground rotating around its horizontal axis by 180 degrees, causing thereby the observational lens 9 to turn up, and the mandrel 6 to move down towards the approaching earth surface.

As depicted in FIGS. 1-4, the unmanned aerial vehicle according to the invention, has a recess 2 in the fuselage 3 with an electrically operated mandrel lock 8. The electronically operated mandrel lock 8 is placed in the recess 2, with detachably attached container 4 with the surveillance head 1 containing the lens 9, the parachute 5, and the main power supply batteries not shown in the drawing, by means of the mandrel 6. The container 4 may also comprise exchangeable modules as equipment required to carry out a given surveillance or patrolling mission.

The object of the invention is to eliminate the drawbacks of the known methods, wherein a container located in the recess at the bottom part of the fuselage can be detached, and then said container is moved outside the fuselage, and with the help of parachute the container descends into a desired place and the lightened aircraft is caused to land in some other place.

After the container is detached from the fuselage, the parachute fixed near the surveillance head forces the falling container to turn around its horizontal axis by 180 degrees causing the lens of the surveillance head to tilt up.

After the container is detached from the fuselage, the electrical engine which drives the propeller turns off, and the propeller collapses along the axis of the fuselage, and then the lightened aircraft is guided to slide landing by means of the flight control system powered by auxiliary batteries.

The subject of the invention is also to provide a surveillance unmanned aerial vehicle characterized in that said vehicle is equipped with an electronically controlled lock situated in a recess of the fuselage, which detachably fixes a container equipped with at least one parachute, wherein the parachute is placed at the bottom part of the container on the side of the surveillance head.

The electronically operated lock co-functions with a lock mandrel mounted on the container.

The container contains main power supply batteries and systems which control the surveillance head.

Thanks to the invention, an expensive photographing or film equipment can be safely brought back to the ground, as well as the heaviest element of UAV equipment, that is the main power supply batteries, thus the lightened vehicle can be brought to slide landing with the use of the flight control system powered by auxiliary batteries.

The invention provides also a simple and cheap air vehicle capable of reliable detachment from the fuselage valuable photo or film equipment, and the heaviest element of UAV equipment, which is the main power supply batteries.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto an thereby. Accordingly, for an appreciation of the true scope and breadth of the invention, reference should be made to the following claims.

What is claimed is:

1. A method of landing of an unmanned aerial vehicle driven by an electric engine, containing the main power supply batteries, surveillance head control systems, transmitting and receiving systems, a flight control system, and a container equipped with a surveillance head with a looking down lens placed in a recess at the bottom part of the fuselage, wherein the unmanned air vehicle is lightened at the last stage of flight shortly before landing, characterized in that the container is detached from the recess situated at the bottom part of the fuselage, and then the container is moved outside the fuselage and descended by means of a parachute onto a requested place, and the lightened vehicle lands in another location.

2. The method according to claim 1, characterized in that when the container is detached from the fuselage, the parachute fixed near the surveillance head forces the falling container to rotate around its horizontal axis by 180 degrees causing the lens of the surveillance head to turn up.

3. The method according to claim 1, characterized in that when the container is detached from the fuselage, an electric engine driving the propeller is turned off, and after this the propeller collapses along the axis of the fuselage, and the lightened vehicle is brought down to slide landing with the use of the flight control system powered by auxiliary batteries.

4. The method according to claim 2, characterized in that when the container is detached from the fuselage, an electric engine driving the propeller is turned off, and after this the propeller collapses along the axis of the fuselage, and the lightened vehicle is brought down to slide landing with the use of the flight control system powered by auxiliary batteries.

5. An unmanned aerial vehicle driven by an electric engine, containing a surveillance head control system, transmitting and receiving systems, a battery, and a container equipped with a surveillance head with a looking down lens placed in a recess at the bottom part of the fuselage, characterized in that in a recess of the fuselage an electronically controlled lock is mounted, whereby the lock fixes in a detachable manner a container furnished with at least one parachute placed in the lower part of the container, on the side of the surveillance head.

6. The unmanned aerial vehicle according to claim 5, characterized in that the electronically controlled lock co-functions with a lock mandrel mounted on the container.

7. The unmanned aerial vehicle according to claim 6, characterized in that the container comprises the main power supply batteries and the control systems of the surveillance head.

8. The unmanned aerial vehicle according to claim 5, characterized in that the container comprises the main power supply batteries and the control systems of the surveillance head.
